(19) United States
(12) Patent Application Publication
(10) Pub. No.: US 2011/0305468 A1
(43) Pub. Date: Dec. 15, 2011

(54) IMAGE FORMING APPARATUS

(75) Inventor: Shigeru Fujiwara, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/156,468

(22) Filed: Jun. 9, 2011

Related U.S. Application Data
(60) Provisional application No. 61/352,960, filed on Jun. 9, 2010.

(51) Int. Cl. G03G 15/00; G03G 15/02; G03G 15/08

(52) U.S. Cl. 399/27; 399/44; 399/50; 399/49

(57) ABSTRACT

An image forming apparatus includes an electrostatic latent image forming unit, a developing unit, an apparatus information acquisition unit to acquire apparatus information relating to the image forming apparatus, a toner image condition information acquisition unit using the apparatus information and acquiring toner image condition information relating to a condition at a time of toner image formation by the electrostatic latent image forming unit and the developing unit, a reference toner image forming unit controlling the electrostatic latent image forming unit and the developing unit based on the toner image condition information and forming a reference toner image on the image carrier, a toner adhesion amount information acquisition unit to acquire information relating to a toner adhesion amount in the reference toner image, and a supply amount correction unit using the information relating to the toner adhesion amount and correcting a toner supply amount to the developing unit.

### CROSS-REFERENCE TO RELATED APPLICATION

This application is based upon and claims the benefit of priority from U.S. provisional application 61/352,960, filed on Jun. 9, 2010; the entire contents of which are incorporated herein by reference.

### FIELD

Embodiments described herein relate generally to a technique relating to an image forming apparatus in which a variation range of toner density of a developer can be reduced even if a toner density sensor is not provided.

### BACKGROUND

Hitherto, as a developer of an image forming apparatus of an electrophotographic system, a two-component developer in which a toner and a carrier are mixed is widely used from the viewpoint of life and image quality. In a two-component developing device using the two-component developer, an amount of toner corresponding to that of toner consumed by image formation is required to be supplied into the developing device. In general, a magnetic or optical toner density sensor is provided in the developing device to detect the toner density of the developer, and toner supply control is performed. Besides, there are proposed a pixel counter toner supply control system in which the amount of consumed toner is estimated from the number of pixels of image data and toner supply is performed, and a toner adhesion amount detection toner supply control system in which an optical toner adhesion amount sensor detects the toner adhesion amount of a test pattern and toner supply is performed in order to control image density by toner supply control.

Further, a system using both the pixel counter toner supply control system and the toner adhesion amount detection toner supply control system is also proposed. In this system, the toner supply amount per sheet obtained from the image density information of an image information signal is corrected (increased or decreased) based on the detection result of the toner adhesion amount (toner density) of the test pattern obtained at a specified timing and the toner supply control is performed.

However, there is a case where the characteristics of the developer are changed by the variation of temperature and humidity environment and the elapsed time from start of use of the developer and the like, and an over-toner (toner density is excessive) or an under-toner (toner density is too small) state occurs, and fogging (scumming), toner scattering or carrier adhesion (carrier development) occurs.

### DESCRIPTION OF THE DRAWINGS

FIG. 1 is a view showing an outline of an image forming apparatus of an embodiment.

FIG. 2 is a view showing an outline of a transfer unit of the image forming apparatus of the embodiment.

FIG. 3 is a view showing an outline of a toner adhesion amount sensor of the image forming apparatus of the embodiment.

FIG. 4 is a view showing a control block of the image forming apparatus of the embodiment.

FIG. 5 is a view showing a function block of the image forming apparatus of the embodiment.

FIG. 6 is a view showing a processing flow of toner supply amount correction of the image forming apparatus of the embodiment.

FIG. 7 is a schematic view showing a threshold of toner adhesion amount deviation.

FIG. 8 is a flowchart showing a basic operation of toner supply control.

FIG. 9 is a schematic view showing timing of the toner supply control.

FIG. 10 is a graph showing a relation between the integrated number of pixels and a toner supply time.

FIG. 11 is a schematic view showing a potential relation at the time of development.

FIG. 12 is a graph showing a relation between a charge grid bias and a photoreceptor surface potential at the time of development.

FIG. 13 is a view illustrating a table showing data of photoreceptor coefficients.

FIG. 14 is a graph showing open-loop control of development contrast potential Vc by temperature and humidity.

FIG. 15 is a graph showing open-loop control of the development contrast potential Vc by developer life.

FIG. 16 is a graph showing open-loop control of laser power by photoconductive drum temperature.

FIG. 17 is a graph showing open-loop control of the laser power by photoreceptor life.

FIG. 18 is a graph showing the transition of the development contrast potential Vc with respect to a passing sheet count.

FIG. 19 is a graph showing the transition of toner density with respect to a passing sheet count.

FIG. 20 is a graph showing the transition of image density with respect to a passing sheet count.

FIG. 21 is a schematic sectional view of an image forming apparatus of another embodiment.

### DETAILED DESCRIPTION

In general, according to one embodiment, an image forming apparatus includes an electrostatic latent image forming unit, a developing unit, an apparatus information acquisition unit, a toner image condition information acquisition unit, a reference toner image forming unit, a toner adhesion amount information acquisition unit, and a supply amount correction unit.

The electrostatic latent image forming unit forms an electrostatic latent image corresponding to an image signal on an image carrier. The developing unit is applied with a voltage and develops the electrostatic latent image with a two-component developer including a toner and a carrier to form a toner image. The apparatus information acquisition unit acquires apparatus information as information relating to the image forming apparatus. The toner image condition information acquisition unit uses the apparatus information acquired by the apparatus information acquisition unit and acquires toner image condition information as information relating to a condition at the time of toner image formation by the electrostatic latent image forming unit and the developing unit. The reference toner image forming unit controls the electrostatic latent image forming unit and the developing unit based on the toner image condition information acquired by the toner image condition information acquisition unit and forms a reference toner image on the image carrier. The toner adhesion amount information acquisition unit acquires information relating to a toner adhesion amount in the reference toner image formed by the reference toner image forming unit. The supply amount correction unit uses the information relating to the toner adhesion amount acquired by the toner adhesion amount information acquisition unit and corrects a toner supply amount to the developing unit.

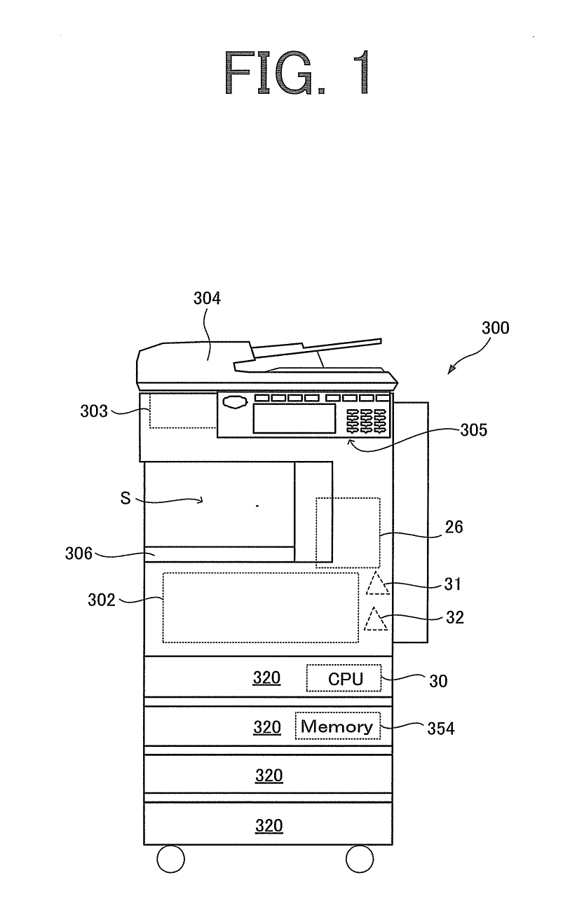

First, a structure of an MFP (Multi Function Peripheral) as an example of an image forming apparatus of an embodiment will be described with reference to FIG. 1. FIG. 1 is an outer appearance view showing an outline of the image forming apparatus.

The image forming apparatus 300 includes paper feed cassettes 320, and the paper feed cassettes 320 contain plural sheets. The number of the paper feed cassettes 320 may be one or two or more. The plural sheets contained in the paper feed cassette 320 are separated one by one by a pickup roller, and are supplied to a sheet conveyance path. The sheets pass through a sheet conveyance path and are supplied to a transfer unit 302.

A CPU 30 performs various processings in the image forming apparatus 300. The CPU 30 executes programs stored in a memory 354 and realizes various functions.

The memory 354 includes, for example, a RAM (Random Access Memory) as a volatile storage device, a ROM (Read Only Memory) as a non-volatile storage device, a HDD (Hard disk drive) or the like.

The image forming apparatus 300 may include an ASIC (Application Specific Integrated Circuit). Besides, it is needless to say that the CPU 30 can be replaced with an MPU (Micro Processing Unit) capable of executing an arithmetic operation comparable to the CPU 30. Further, the HDD or the like constituting the memory 354 can also be replaced with a storage device such as a flash memory.

An image reading device 303 scans an image of a sheet document and a book document and generates image data. FIG. 1 shows a part of the image reading device 303. A device (ADF: Auto Document Feeder) 304 to automatically feed a document is disposed on the image reading device 303.

An operation panel 305 for inputting various information to the image forming apparatus 300 is provided at an upper part of the image forming apparatus 300. The operation panel 305 can be constructed of, for example, a button switch or a liquid crystal panel.

The transfer unit 302 forms a toner image on a sheet based on image data. The image data includes, for example, image data transmitted to the image forming apparatus 300 from an external equipment (for example, a personal computer), and image data generated by the reading operation of the image reading device 303. In the transfer unit 302, specifically, after an electrostatic latent image corresponding to the image data is formed on a photosensitive surface of a photoreceptor, toner is supplied and the toner image is formed.

The toner image formed on the surface of the photoreceptor is transferred to a sheet. Specifically, the toner image on the photoreceptor can be transferred to the sheet by causing the sheet to contact the surface of the photoreceptor. After the toner image on the photoreceptor is transferred to an intermediate transfer belt, the toner image can also be transferred to the sheet from the intermediate transfer belt.

The toner image transferred to the sheet is heated and fixed by a fixing device 26. The sheet on which the toner image is fixed passes along the sheet conveyance path and is discharged to a paper discharge space S. A paper discharge tray 306 for stacking sheets is disposed in the paper discharge space S.

Besides, the image forming apparatus 300 of the embodiment includes a temperature sensor 31 to detect temperature in the apparatus and a humidity sensor 32 to detect humidity in the apparatus.

Next, the transfer unit 302 of the image forming apparatus 300 of the embodiment will be described.

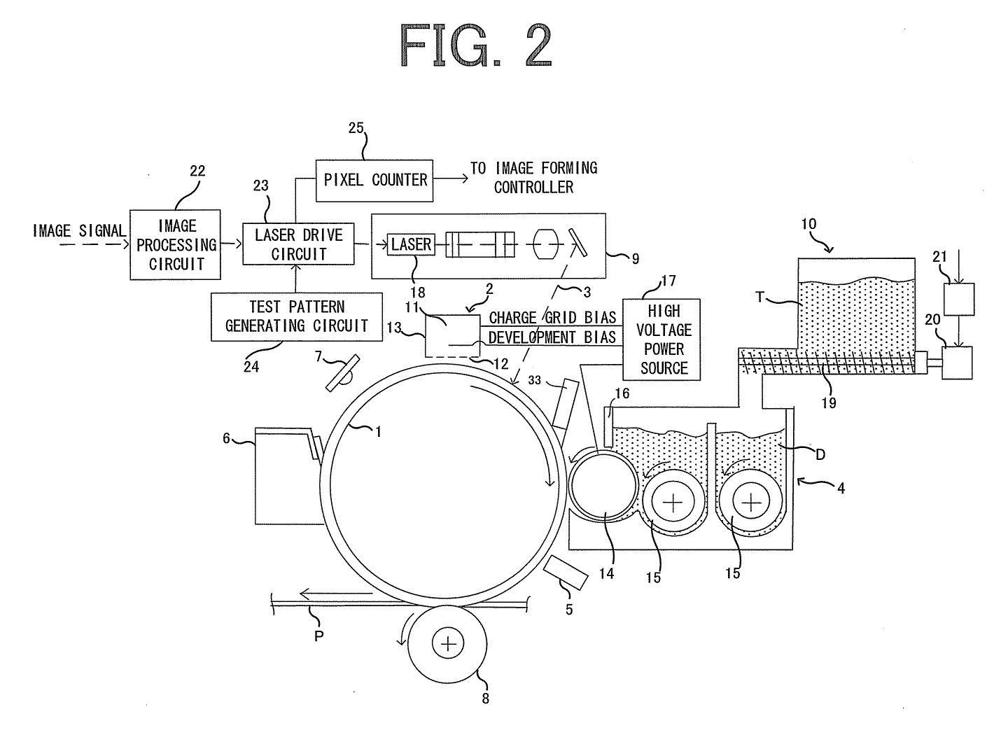

As shown in FIG. 2, a photoconductive drum 1 (corresponding to an image carrier) of the transfer unit 302 includes an organic photoconductor (OPC) on a support member surface and rotates in an arrow direction. A corona charger 2, a laser exposure unit 9, a developing device 4, a toner adhesion amount sensor 5, a transfer roller 8, a cleaner 6 and a charge-removal lamp 7 are arranged around the photoconductive drum 1.

The corona charger 2 (corresponding to a charging unit) is applied with a voltage (charge grid bias) and uniformly charges the surface of the image carrier. Specifically, the corona charger 2 is a scorotron corona charger, and a high voltage power source 17 applies a negative polarity voltage to a wire electrode 11 and a grid electrode 12 so that the corona charger negatively and uniformly charges the photoconductive drum 1. Besides, in this embodiment, a laser exposure unit 9 (corresponding to an exposure unit) performs image exposure corresponding to an image signal and with a specified exposure amount (laser power) onto the photoconductive drum 1 charged by the corona charger 2. An image signal converted into a digital signal is subjected to an image processing by an image processing circuit 22, and is transmitted to a laser drive circuit 23. A laser (semiconductor laser) 18 emits a light according to the image signal. The laser exposure unit 9 performs scanning exposure with a laser light 3 at a resolution of 600 dpi, and an electrostatic latent image is formed on the photoconductive drum 1.

The developing device 4 (corresponding to a developing unit) containing a two-component developer D, which includes a toner and a carrier and in which the toner is charged to a negative polarity, is applied with a voltage (development bias), develops the electrostatic latent image on the photoconductive drum 1 and forms a toner image. Specifically, the developing device 4 includes a pair of conveyance augers 15 to agitate and convey the two-component developer D, a developing roller 14 to which a development bias obtained by superimposing a negative polarity DC voltage on an AC voltage is applied from the high voltage power source 17 and which includes therein not-shown magnets including plural magnetic poles, carries the two-component developer D in a layer shape and rotates in an arrow direction, and a doctor blade 16 to adjust so that a toner layer of specific thickness is formed on the developing roller 14. Incidentally, in this embodiment, the developing device 4 is not provided with a toner density sensor to detect the toner density of the two-component developer.

A toner cartridge 10 containing toner T is coupled to the developing device 4, a toner supply auger 19 is rotated by driving of a toner motor 20 connected to a toner motor drive circuit 21, and the toner T is supplied from the toner cartridge 10 to the developing device 4. The toner image formed on the photoconductive drum 1 is transferred to a sheet P supplied from a not-shown paper feed device by a transfer roller to which a positive polarity transfer bias is applied from a not-shown high voltage power source, and is fixed by the fixing device 26, and then is discharged to the outside of the machine. On the other hand, after a transfer residual toner on the photoconductive drum 1 is cleaned by the cleaner 6, the photoconductive drum 1 is diselectrified by the charge removal lamp 7, and is used for next formation of an electrostatic latent image.

A pixel counter 25 connected to the laser drive circuit 23 is a counter (circuit) to integrate the number of laser light-emitting pixels for each page (for each image), and obtains a toner consumption amount for each page. A test pattern generation circuit 24 connected to the laser drive circuit 23 is a test pattern generation circuit for detecting a toner adhesion amount.

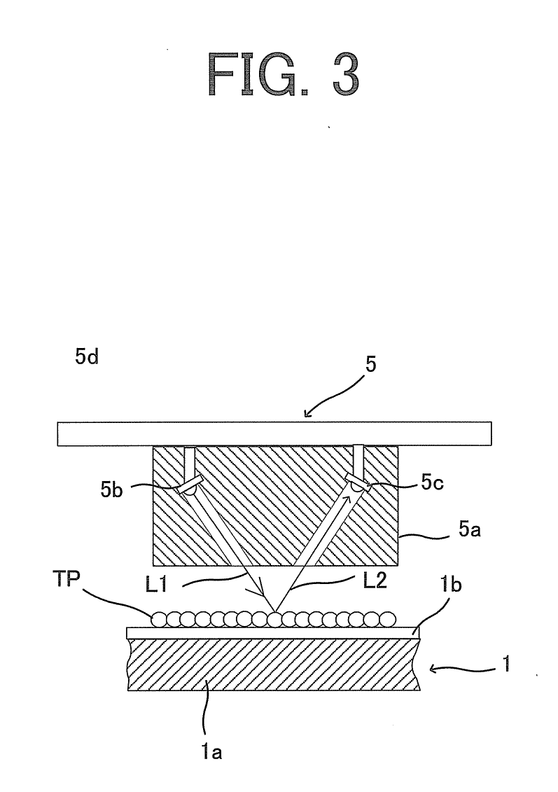

FIG. 3 is a schematic sectional view of the toner adhesion amount sensor 5 which is an optical sensor including a housing 5a, a light emitting element 5b and a light receiving element Sc provided in the housing 5a, and a sensor substrate 5d provided with a not-shown sensor circuit. The toner adhesion amount sensor is provided to face the photoconductive drum 1 including a drum 1a made of aluminum and an organic photoconductor 1b, irradiates a projection light L1 to a test pattern formed on the photoconductive drum 1 at a specified timing, receives a reflected light L2, and detects the toner adhesion amount of the test pattern.

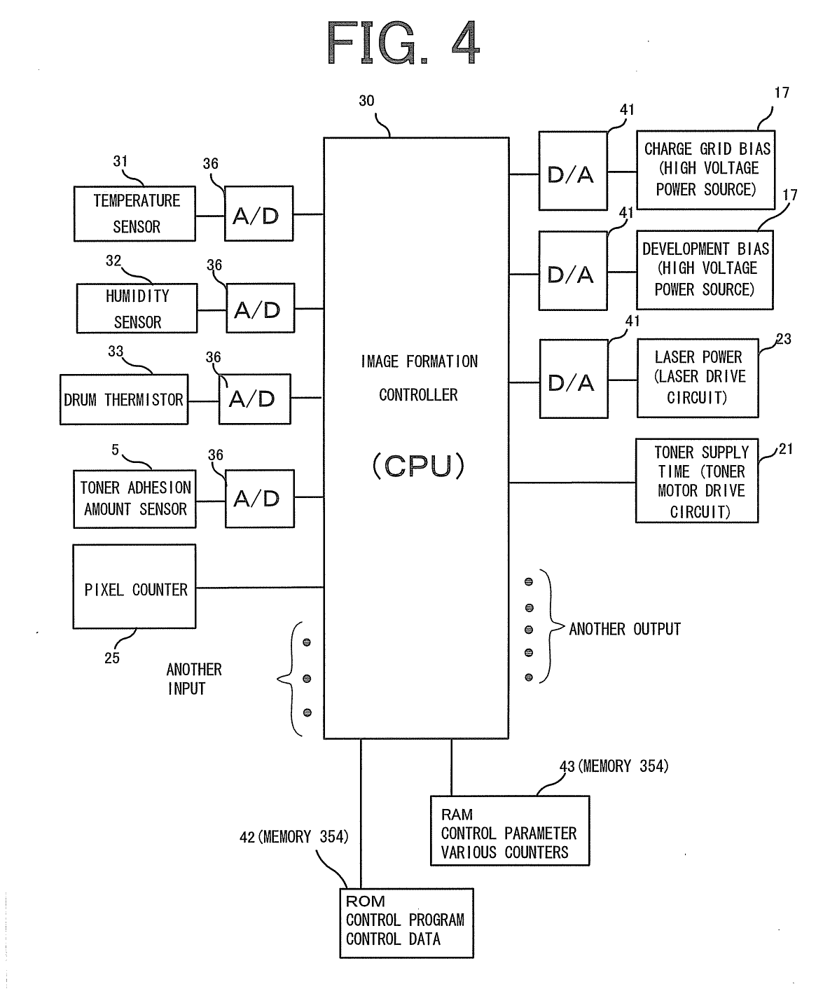

FIG. 4 is a control block diagram of the image forming apparatus 300 of the embodiment, which relates to toner supply amount control. In FIG. 4, a temperature sensor 31 to measure temperature in the apparatus, a humidity sensor 32 to measure humidity in the apparatus, a drum thermistor 33 to measure the surface temperature of the photoconductive drum 1, and the toner adhesion amount sensor 5 are connected to the input side of an image forming controller (CPU) 30 through analog-digital converters (A/D) 36, and the foregoing pixel counter 25 is further connected. On the other hand, a charge grid bias control voltage, a development bias control voltage, a laser power control voltage and a toner supply motor ON signal are outputted from the outside side through digital-analog converters (D/A). Further, a ROM 42 storing control programs and control data and a RAM 43 storing control parameters and count values of consumables such as the photoconductive drum are connected to the image forming controller 30. In this embodiment, the memory 354 includes the ROM 42 and the RAM 43. Incidentally, another not-shown input and output (I/O) is connected to the image forming controller 30, and control relating to image formation is performed.

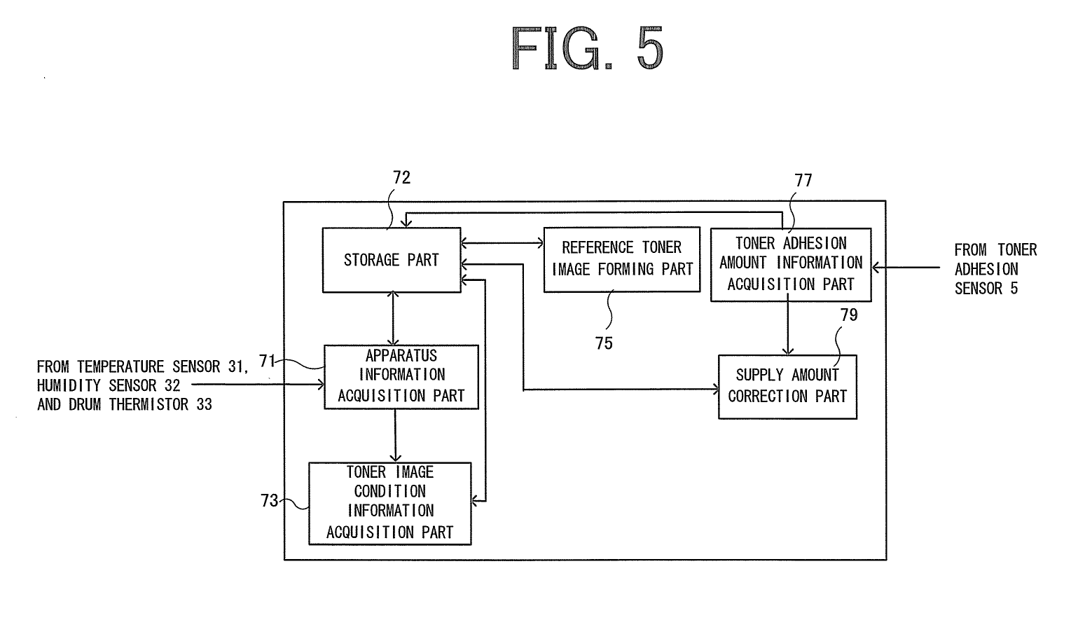

FIG. 5 is a function block diagram relating to the toner supply amount control of the image forming apparatus 300 of the embodiment.

As shown in FIG. 5, the image forming apparatus of the embodiment includes an apparatus information acquisition unit 71, a toner image condition information acquisition unit 73, a reference toner image forming unit 75, a toner adhesion amount information acquisition unit 77, a supply amount correction unit 79 and a storage unit 72. The image forming controller (CPU) 30 executes programs read in the memory 354 and realizes the respective function blocks.

The storage unit 72 stores information relating to a driving time (also called a photoreceptor life) from start of use of the photoconductive drum 1, and information relating to the number of times of development (also called a developer life) from start of use of the developer. Incidentally, the image forming controller 30 updates the information relating to the photoreceptor life and the information relating to the developer life stored in the storage unit 72 based on the record (log) of the executed image formation processing.

The apparatus information acquisition unit 71 acquires apparatus information as information relating to the image forming apparatus 300.

In this embodiment, the apparatus information includes information relating to the temperature of the photoconductive drum 1, information relating to the photoreceptor life, information relating to the temperature in the image forming apparatus, information relating to the humidity in the image forming apparatus and information relating to the developer life.

The apparatus information acquisition unit 71 acquires the information relating to the temperature of the photoconductive drum 1 (specifically, the temperature of the surface of the photoconductive drum 1) from the drum thermistor 33. Besides, the apparatus information acquisition unit 71 acquires the information relating to the temperature in the image forming apparatus from the temperature sensor 31, and acquires the information relating to the humidity in the image forming apparatus from the humidity sensor 32. Further, the apparatus information acquisition unit 71 acquires the information relating to the photoreceptor life and the information relating to the developer life from the storage unit 72.

The toner image condition information acquisition unit 73 uses the apparatus information acquired by the apparatus information acquisition unit 71 and acquires toner image condition information as information relating to conditions at the time of toner image formation by the electrostatic latent image forming unit (the corona charger 2 and the laser exposure unit 9) and the developing unit (the developing device 4). In this embodiment, the toner image condition information includes information relating to a voltage (charge grid bias) applied to the corona charger 2, an exposure amount (laser power) when scanning exposure onto the photoconductive drum 1 is performed from the laser optical system unit 9, and a voltage (development bias) applied to the developing device 4.

Specifically, the toner image condition information acquisition unit 73 uses the information relating to the temperature of the photoconductive drum 1 and the information relating to the photoreceptor life and acquires the information relating to the laser power.

Besides, the toner image condition information acquisition unit 73 uses the information relating to the temperature in the image forming apparatus, the information relating to the humidity in the image forming apparatus and the information relating to the developer life, and acquires information relating to a development contrast potential. The development contrast potential is a potential difference between the development bias and a post-exposure potential of the photoconductive drum 1. Next, the toner image condition information acquisition unit 73 acquires the information relating to the charge grid bias and the information relating to the development bias from the information relating to the development contrast potential, the information relating to the temperature of the photoconductive drum 1, the information relating to the photoreceptor life and the information relating to the laser power. The acquisition of the information relating to the laser power, the charge grid bias and the development bias by the toner image condition information acquisition unit 73 will be described later in detail.

The reference toner image forming unit 75 controls the corona charger 2, the laser exposure unit 9 and the developing device 4 based on the toner image condition information acquired by the toner image condition information acquisition unit 73, and forms a reference toner image (test pattern) on the photoconductive drum 1. Specifically, the reference toner image forming unit 75 uses the toner image condition information to adjust the magnitude of the charge grid bias, the magnitude of the laser power and the magnitude of the development bias, and controls the corona charger 2, the laser exposure unit 9 and the developing device 4 to adjust the toner density of the test pattern.

The toner adhesion amount information acquisition unit 77 acquires information relating to the toner adhesion amount of the test pattern, which is formed on the surface of the photoconductive drum 1 based on the control of the reference toner image forming unit 75, from the toner adhesion amount sensor 5.

The supply amount correction unit 79 uses the information relating to the toner adhesion amount of the test pattern acquired by the toner adhesion amount information acquisition unit 77 and corrects the toner supply amount to the developing device 4.

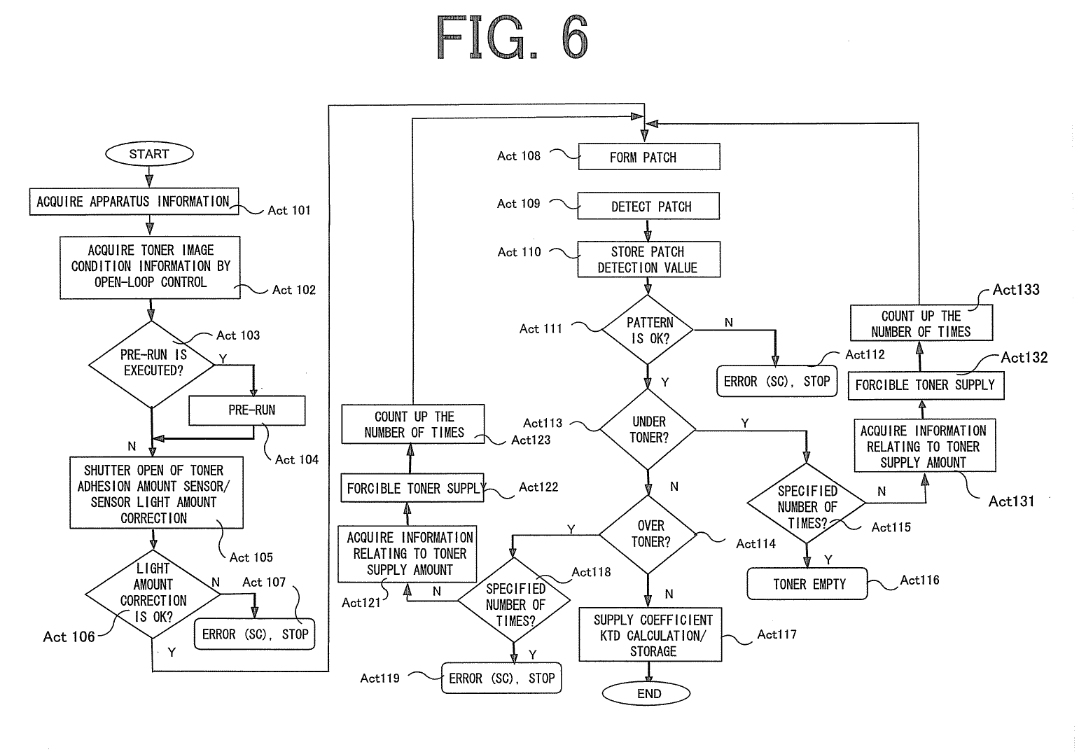

FIG. 6 is a view showing an example of a processing flow of toner supply amount correction control. The toner supply amount correction control is the control to correct the toner supply amount for each page, which is obtained by the pixel counter, based on the toner adhesion amount detection result of the test pattern. The execution timing (start-up timing) of the toner supply amount control is not particularly limited and can be suitably set by those skilled in the art. The execution timing includes, for example, the time of power-ON of the image forming apparatus 3, the time of return from a sleep mode (power-ON of the fixing device 26), the time when the integrated number of printed sheets from the last control reaches a specified number, the time when the number of continuously printed sheets reaches a specified number, and the time when the temperature and humidity vary from the last control time by a specified value or larger.

As shown in FIG. 6, in this embodiment, first, the image forming controller 30 acquires the toner image condition information by an open-loop control.

Specifically, at Act 101, the apparatus information acquisition unit 71 acquires the apparatus information as the information relating to the image forming apparatus 300. At Act 102, the toner image condition information acquisition unit 73 uses the apparatus information acquired by the apparatus information acquisition unit 71 and acquires the toner image condition information. Specifically, the toner image condition information acquisition unit 73 calculates a charge grid bias Vg, a development bias (more specifically, DC development bias) Vdc and laser power (LD-P) by the open-loop control using the apparatus information, and acquires the toner image condition information.

Next, the image forming controller 30 determines whether a pre-run of the image forming apparatus 300 is to be performed (Act 103). When the pre-run is to be performed, the pre-run is performed for a specified time (Act 104). The main object of the pre-run is to agitate the developer D in the developing device 4 before formation of the test pattern. The execution is determined by the start-up timing of this control, and for example, when the image forming apparatus is started from a non-operated state, the pre-run is performed. Next, the image forming controller 30 performs an opening operation of a not-shown shutter of the toner adhesion amount sensor 5 and light amount correction of the light emitting element 5b (the light amount of the light-emitting element is adjusted so that the output of the light-receiving element by the reflected light amount from the surface of the photoconductive drum 1 becomes constant in the state where there is no test pattern) (Act 105). When the output of the light-receiving element and the adjustment value of the light emitting element are abnormal values, it is determined that the light amount correction is abnormal (shutter failure, toner adhesion amount sensor failure, defective cleaning of the photoconductive drum 1, etc.) (Act 106), the control is stopped and an error (service call) is displayed (Act 107).

Next, the reference toner image forming unit 75 forms a toner patch of a test pattern (patch) for toner adhesion amount detection generated by the test pattern generation circuit 24 on the photoconductive drum 1 based on the toner image condition information obtained at Act 102 (Act 108). The toner adhesion amount information acquisition unit 77 acquires the information (hereinafter referred to also as a detection value) relating to the toner adhesion amount of the test pattern from the toner adhesion amount sensor 5 (Act 109). The toner adhesion amount information acquisition unit 77 stores the information relating to the toner adhesion amount in the storage unit 72 (RAM 43) (Act 110). The toner adhesion amount information acquisition unit 77 notifies the supply amount correction unit 79 that the information relating to the toner adhesion amount is stored in the storage unit 72.

Next, the image forming controller 30 determines whether the detection value of the test pattern is an abnormal value (Act 111). When it is determined that the pattern is abnormal (failure of an image forming system), the control is stopped and an error (service call) is displayed (Act 112). In this embodiment, the test pattern is a solid patch pattern having an area ratio of 100%, a width of 20 mm and a length of 30 mm. Besides, the test pattern is detected, for example, ten times at a period of 10 msec, and an average value of eight values except the highest and lowest values is adopted. Incidentally, the test pattern may be a halftone pattern other than the solid pattern having the area ratio of 100%.

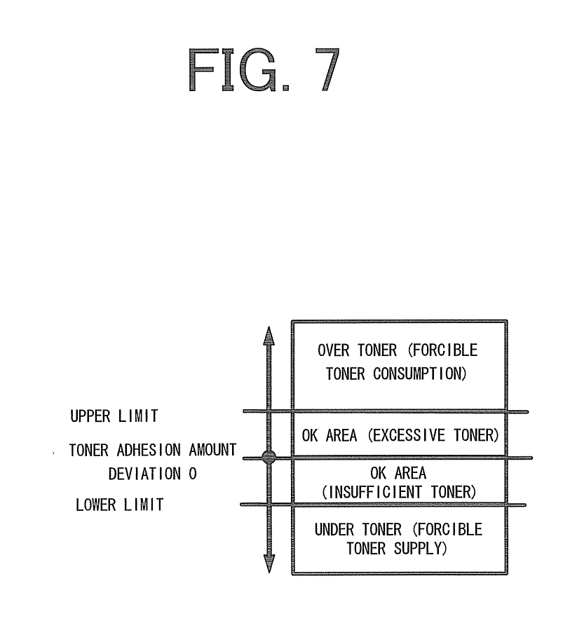

Next, as shown in FIG. 7, the supply amount correction unit 79 uses information relating to an upper limit value and a lower limit value set for a toner adhesion amount deviation as a deviation between a toner adhesion amount detection value and a toner adhesion amount target value, and determines whether processing for causing the toner adhesion amount deviation to become a value less than the upper limit value and larger than the lower limit value is to be performed.

Specifically, the supply amount correction unit 79 first determines whether the toner adhesion amount deviation is the lower limit value or less (Act 113). When it is determined that the toner adhesion amount deviation is the lower limit value or less, the toner density of the developer D is too low (under toner), and the supply amount correction unit 79 performs a processing in a forcible toner supply mode (Act 115, Act 116, Act 131, Act 132, Act 133) for causing the toner adhesion amount deviation to become larger than the lower limit value. The supply amount correction unit 79 first determines the number of times of operation of the forcible toner supply mode (Act 115). When the number is a specified number of times or less, the supply amount correction unit 79 acquires the information relating to the toner supply amount at the time of execution of the toner supply mode from, for example, the storage unit 72 (Act 131). Next, the supply amount correction unit 79 turns ON the toner motor 20 based on the information relating to the toner supply amount to perform the forcible toner supply (Act 132), and counts up the number of times of the forcible toner supply (Act 133), and a return is made to the test pattern formation of Act 108. At Act 115, when it is determined that the number of times of operation of the toner forcible supply mode is the specified number of times or more, the supply amount correction unit 79 determines that a state of toner empty occurs, stops the control, and notifies the user of the toner empty (Act 116). Incidentally, in the forcible toner supply operation at Act 132, the toner supply may be performed by intermittent supply, not continuous supply, in order to prevent insufficient agitation of the developer.

Next, at Act 113, when it is determined that the toner adhesion amount deviation is larger than the lower limit value, at Act 114, the supply amount correction unit 79 determines whether the adhesion amount deviation is the upper limit value or larger. In the case of the upper limit value or larger, it is determined that the toner density of the developer D is too high (over toner), and the supply amount correction unit 79 performs a processing in a forcible toner consumption mode (Act 118, Act 119, Act 121, Act 122, Act 123) in order to cause the toner adhesion amount deviation to become lower than the upper limit value. The supply amount correction unit 79 first determines the number of times of operation of the forcible toner consumption mode (Act 118), and when the number of times is a specified number or less, the supply amount correction unit 79 acquires the information (specifically, information relating to the number of times of test pattern formation) relating to the toner consumption amount at the time of execution of the forcible toner consumption mode from, for example, the storage unit 72 according to the toner adhesion amount deviation (Act 121). Next, the supply amount correction unit 79 performs the image formation of the pattern generated by the test pattern generation circuit 24 using the toner image condition information obtained at Act 102 a specified number of times based on the information relating to the toner consumption amount, and the forcible toner consumption is performed (Act 122). The supply amount correction unit 79 counts up the number of times of the forcible toner consumption (Act 123), and a return is made to the test pattern formation at Act 108. On the other hand, at Act 118, when it is determined that the number of times of operation of the toner forcible consumption mode is the specified number of times or more, the supply amount correction unit 79 determines that an abnormality (failure of the image forming system) occurs, stops the control, and displays a service call (Act 119).

Next, at Act 112, when it is determined that the toner adhesion amount deviation is not the upper limit value or larger (that is, the toner adhesion amount deviation is within the specified range (less than the upper limit value and the lower limit value or larger)), the supply amount correction unit 79 calculates and stores a supply coefficient KTD for correcting the toner supply amount for each page obtained by the pixel counter according to the toner adhesion amount deviation (Act 117), and ends the control. Incidentally, the threshold for light amount correction abnormality, the threshold for pattern abnormality, the toner adhesion amount target value, the upper and the lower limit value of the toner adhesion amount deviation, the information relating to the toner supply amount in the forcible toner supply mode, and the information relating to the toner consumption amount in the forcible toner consumption mode are stored in the storage unit 72 realized by, for example, the RAM.

Incidentally, in the image forming apparatus 300, the toner supply amount correction control of FIG. 6 can be performed also in an adjustment operation at the time of start of use of a developer, a toner empty return operation after replacement of a toner cartridge, and a return operation after error trouble shooting.

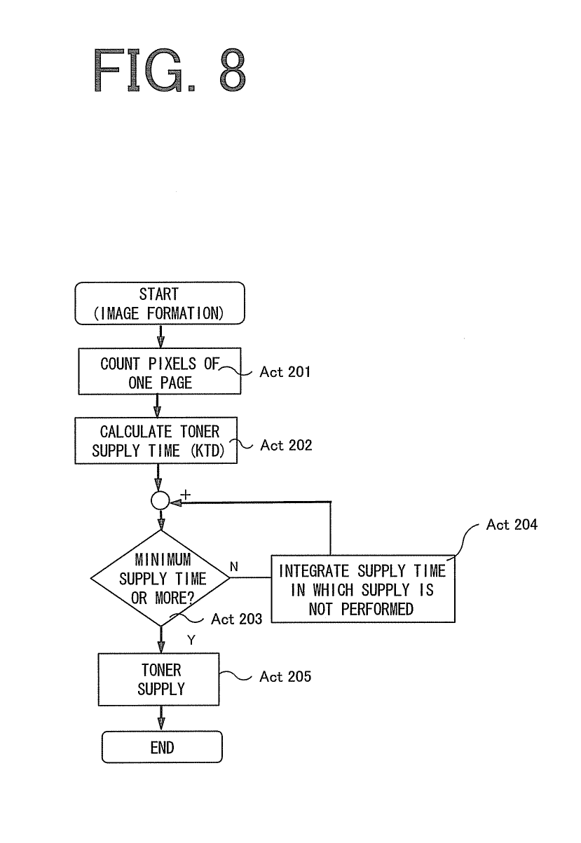

FIG. 8 is a flowchart showing a basic operation of toner supply control. In the toner supply control, the toner supply amount for each page obtained by the pixel counter 25 is corrected by the supply coefficient KTD obtained from the toner adhesion amount detection result of the test pattern and the toner supply is performed.

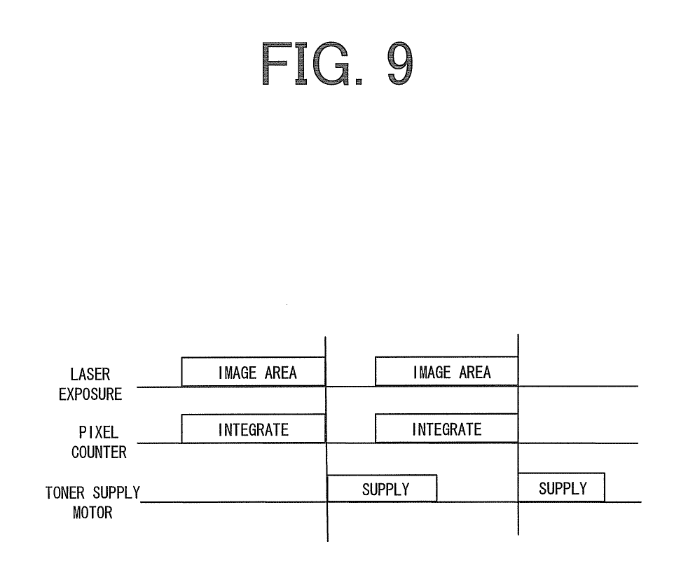

FIG. 9 is a schematic view showing timings of the toner supply control. The pixel counter 25 counts the pixel integrated value simultaneously with the laser exposure of one page corresponding to the image data, and the toner supply is performed almost simultaneously with the end of the laser exposure of one page.

In FIG. 8, the pixel counter 25 first counts the pixel integrated value for each page in synchronization with the image formation (Act 201). Next, the supply amount correction unit 79 calculates the toner supply time from the pixel integrated value and the supply coefficient KTD obtained by the toner supply amount correction control (Act 202), and determines whether the toner supply time is a minimum supply time or less (Act 203). When the time is the minimum supply time or less, the supply amount correction unit 79 does not supply toner, and adds the time to the supply time for next page (Act 204). When the toner supply time is the minimum supply time or more, the supply amount correction unit 79 drives the toner supply motor 20, and performs the toner supply (Act 205). When the image formation is ended, the toner supply control is ended.

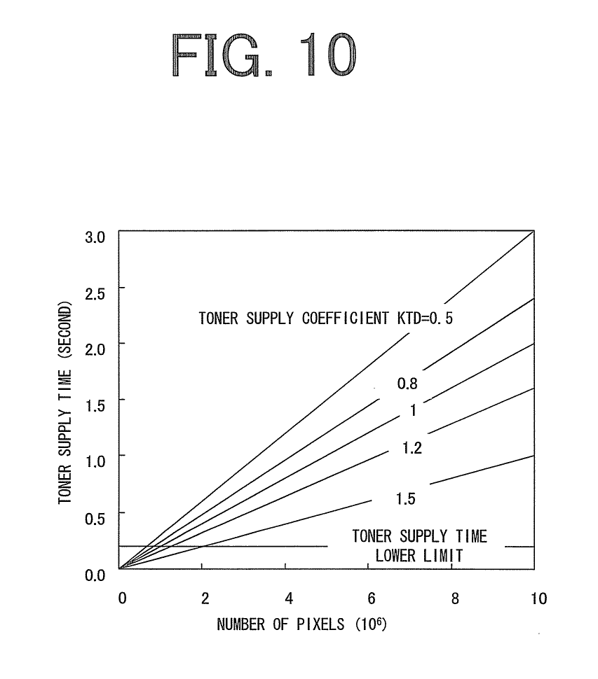

FIG. 10 is a graph showing a relation between the integrated number of pixels and the toner supply time, and correction is performed by the supply coefficients KTD for the respective supply coefficients KTD. When the value of the toner adhesion amount deviation as the deviation between the toner adhesion amount detection value and the toner adhesion amount target value is 0, the value of the supply coefficient KTD is KTD=1, when the toner adhesion amount deviation is plus (dense), KTD<1, and when the toner adhesion amount deviation is minus (thin), KTD>1. In the case of this embodiment, the toner adhesion amount is corrected by multiplication of the supply coefficient KTD. By performing the correction in this way, the toner supply amount is adjusted so as to approach a specified toner adhesion amount, that is, a specified image density. Besides, in order to prevent the toner supply amount from becoming unstable because the toner supply time is too short, the toner supply time lower limit value is set. When the toner supply time calculated for each page is the toner supply time lower limit value or less, the toner supply is not performed for the page, and the time is added to the toner supply time for the next page.

Acquisition of Toner Image Condition Information

Next, acquisition of toner image condition information under open-loop control by the toner image condition information acquisition unit 73 will be described below.

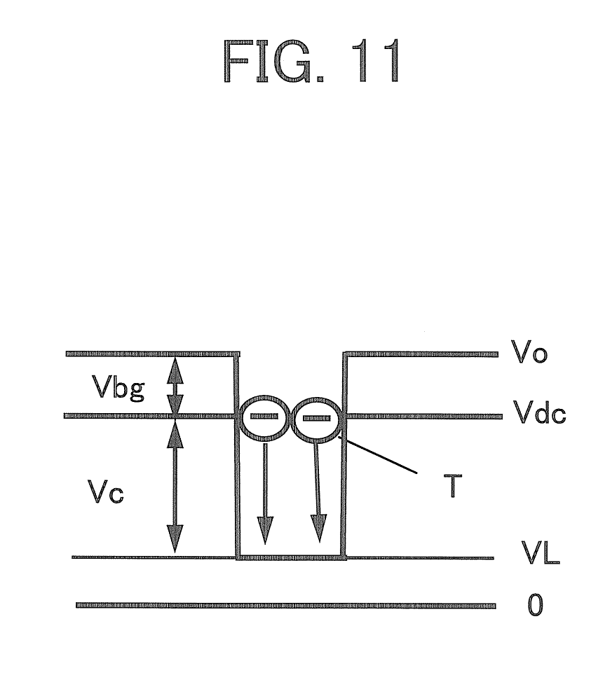

FIG. 11 is a schematic view showing a potential relation at the time of development. In FIG. 11, Vo denotes a photoreceptor charging potential, Vdc denotes a DC development bias, VL denotes a post-exposure potential of a test pattern, Vc denotes a development contrast potential determined by a difference between Vdc and VL, and Vbg denotes a background contrast potential determined by a difference between Vo and Vdc. The polarities of Vo, Vdc and VL are minus and are omitted. In FIG. 11, the toner T placed in the potential Vdc and charged to the minus polarity (that is, the toner T in the developer D on the developing roller 14 to which Vdc is applied) is subjected to reversal development with respect to the potential VL as the potential at the exposure unit side, and the development toner amount, that is, the toner adhesion amount is adjusted by Vc. On the other hand, with respect to Vbg as the potential at the non-exposure portion (non-image portion) side, the value of Vbg is set so that the adhesion amounts of fogging toner and carrier of the non-image portion are adjusted, and both become small levels.

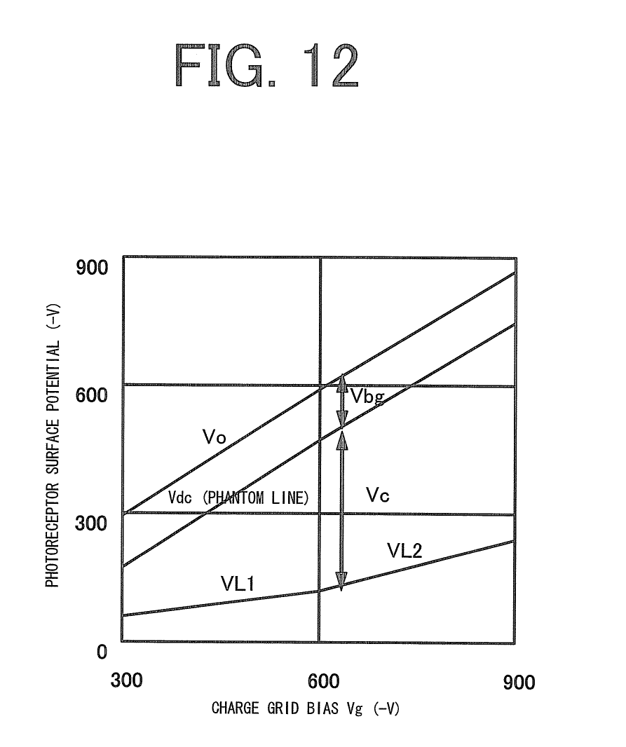

FIG. 12 corresponds to the potential relation at the time of development in FIG. 11 and is a graph showing a relation between a charge grid bias Vg and a photoreceptor surface potential (photoreceptor charge potential Vo, solid post-exposure potential VL) at the time of development. In FIG. 12, Vo and VL are expressed by straight lines (first-order approximate expressions) as represented by the following expressions with respect to the charge grid bias Vg.

Incidentally, VL is expressed by two straight lines of VL1 and VL2 in which the value of Vg is larger than VL1.

Vo=K1Vg+K2 (expression 1)

VL1=K3Vg+K4 (expression 2)

VL2=K5Vg+K6 (expression 3)

The coefficients K1 to K6 of these first-order approximate expressions are photoreceptor coefficients. Incidentally, Vdc is represented by a straight line (phantom line) in which Vbg is constant and which is parallel to Vo.

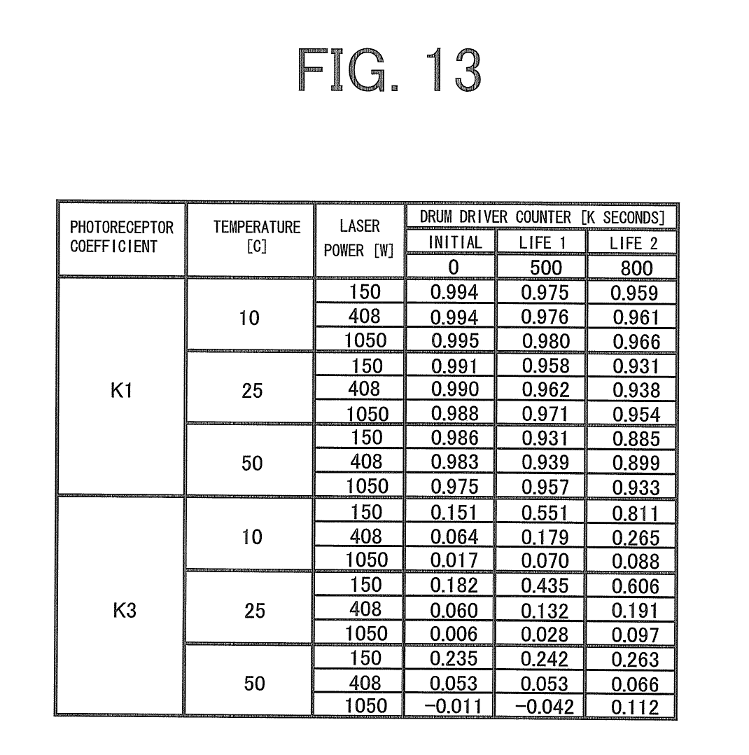

FIG. 13 is a table showing data of the photoreceptor coefficients K1 and K3. The coefficients K1 and K3 are calculated by performing linear interpolation between two points in the table with respect to values of three points of the temperature (° C.) of the photoreceptor, the laser power (μW) and the driving time (photoreceptor life) (Ksec) of the photoconductive drum 1, which are given as the information of the image forming apparatus 300. In FIG. 13, life 1 represents that 500K seconds pass since start of driving, and life 2 represents that 800K seconds pass since start of driving. Although data is not shown for K2, K4, K5 and K6, calculation is performed similarly to K1 and K3.

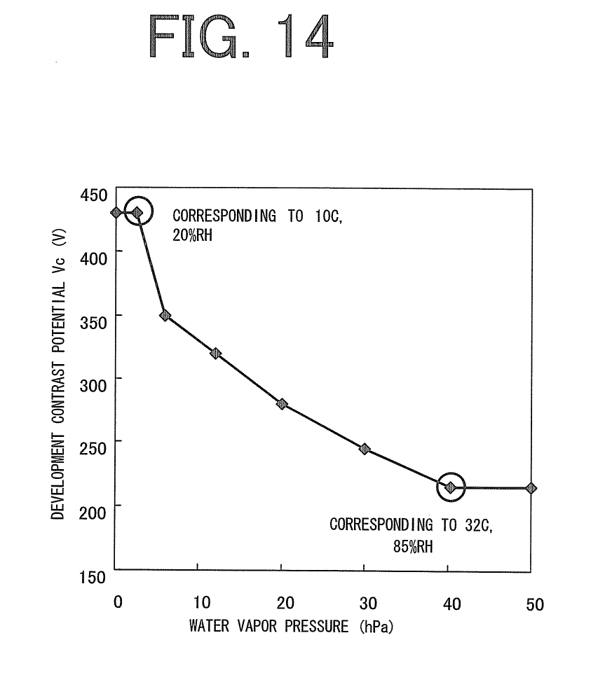

FIG. 14 is a graph showing the open-loop control of the development contrast potential Vc by the temperature and humidity. The horizontal axis indicates water vapor pressure (hPa) obtained by multiplying saturated water vapor pressure (hPa) by relative humidity (% RH), in which temperature (° C.) and humidity (% RH) are given, and with respect to the temperature (° C.), the saturated water vapor pressure (hPa) is obtained from the following tetens approximate expression: saturated vapor pressure (T)=6.11×107.5T/(T+237.3) (hPa) T: temperature (° C.), and indicates humidity corresponding to absolute humidity. The vertical axis indicates the development contrast potential Vc(V). As is understood from FIG. 14, the water vapor pressure (hPa) is obtained from the temperature (° C.) and the relative humidity (% RH) which are given as the information of the image forming apparatus, the linear interpolation is performed between the relevant two points, and the development contrast potential Vc(V) of the temperature and humidity factor is calculated.

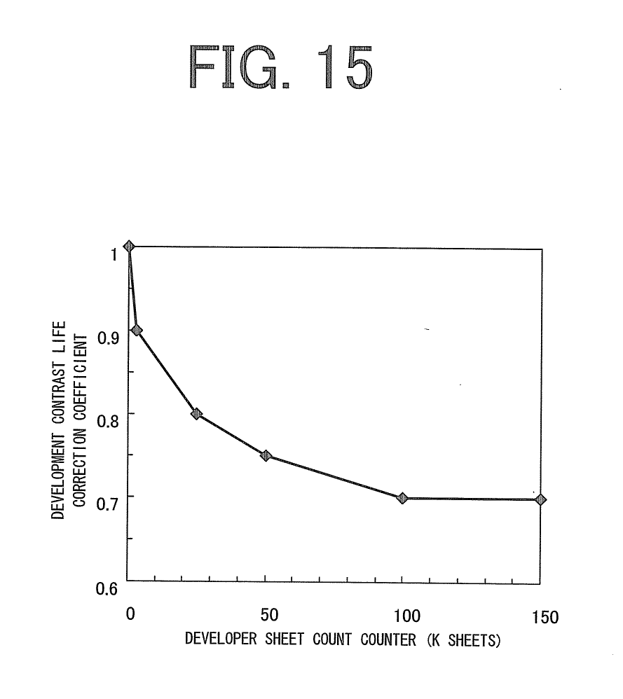

FIG. 15 is a graph showing the open-loop control of the development contrast Vc by the developer life. The horizontal axis indicates the developer life (developer sheet count counter), and the vertical axis indicates the correction coefficient (development contrast life correction coefficient) of the development contrast potential corresponding to the developer life. In FIG. 15, the linear interpolation is performed between the relevant two points from the developer sheet count counter given as the information of the image forming apparatus, and the development contrast life correction coefficient is calculated. The final development contrast potential Vc(V) included in the toner image condition information is obtained by multiplying the development contrast Vc calculated in view of the temperature and humidity factor obtained in FIG. 14 by the development contrast life correction coefficient calculated in view of the developer life factor obtained in FIG. 15.

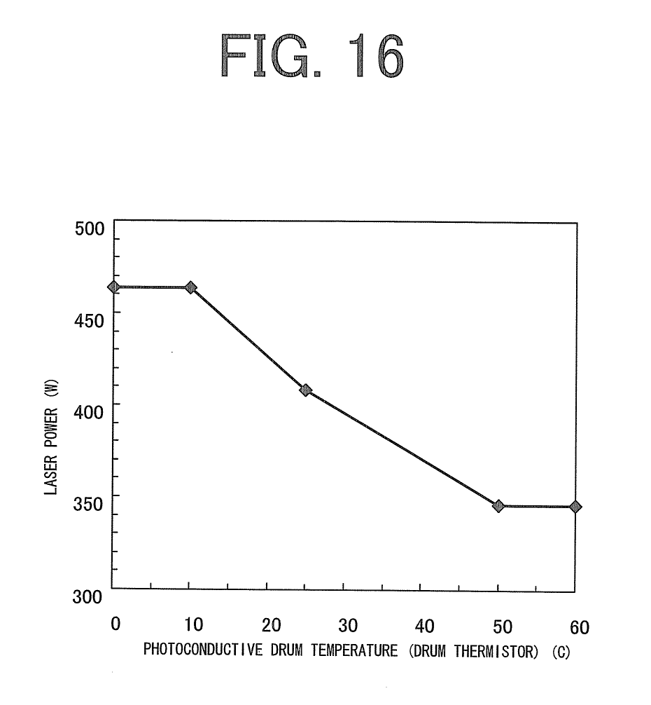

FIG. 16 is a graph showing the open-loop control of the laser power by the photoconductive drum temperature. The horizontal axis indicates the photoconductive drum temperature (drum thermistor, ° C.), and the vertical axis indicates the laser power (μW). In FIG. 16, the linear interpolation is performed between the relevant two points from the drum temperature (° C.) given as the information of the image forming apparatus, and the laser power (μW) is calculated.

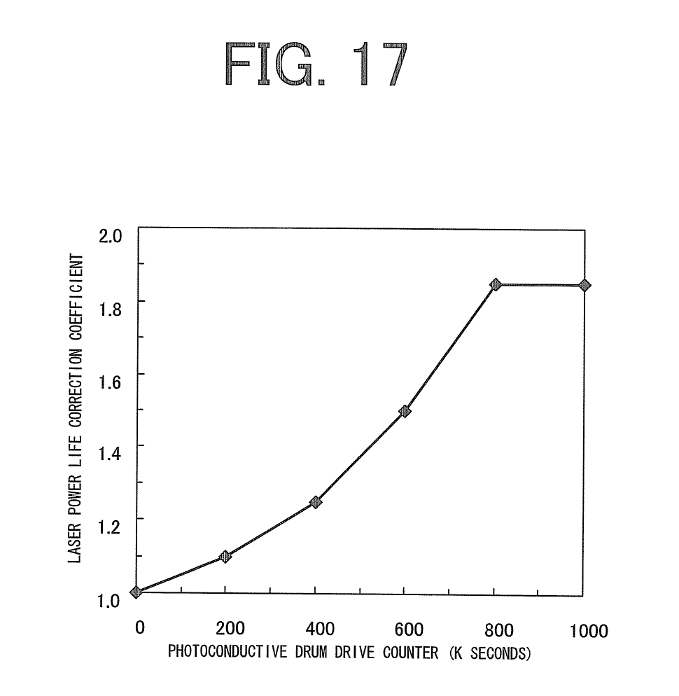

FIG. 17 is a graph showing the open-loop control of the laser power by the photoreceptor life. The horizontal axis indicates the photoconductive drum driving time (photoreceptor life) (Ksec), and the vertical axis indicates the correction coefficient (laser power life correction coefficient) of laser power corresponding to the photoreceptor life. In FIG. 17, the linear interpolation is performed between the relevant two points from the photoconductive drum drive counter (Ksec) given as the information of the image forming apparatus, and the laser power life correction coefficient is calculated. The final laser power (LD-P) (μW) included in the toner image condition information is obtained by multiplying the laser power at the photoconductive drum temperature obtained in FIG. 16 by the laser power life correction coefficient of the life factor obtained in FIG. 17.

The calculation of the image forming condition by the open-loop control at the time of test pattern preparation described above is performed at Act 102 in the toner supply amount correction control described in FIG. 6. In summary, the calculation can be performed in accordance with the following procedures (1) to (3).

(1) The development contrast potential is calculated from the temperature and humidity which are given as the information of the image forming apparatus and the information relating to the developer life. Besides, the laser power is calculated from the information relating to the photoconductive drum temperature and the photoreceptor life.

(2) The photoreceptor coefficients K1 to K6 are obtained by applying the temperature of the photoreceptor given as the information of the image forming apparatus, the information relating to the photoreceptor life, and the laser power obtained in (1) to the photoreceptor coefficient table.

(3) The charge grid bias Vg and the DC development bias Vdc are obtained by applying the development contrast potential Vc obtained in (1), the set (fixed value) background contrast potential Vbg and the photoreceptor coefficients K1 to K6 to the following expressions obtained by expanding the expression 1 and the expression 2.

With respect to VL1,

Vg=(Vc+Vbg+(K2−K4))/(K1−K3) expression 4

Vdc=(K1−K3)Vg−Vbg expression 5

With respect to VL2,

Vg=(Vc+Vbg+(K2−K6))/(K1−K5) expression 6

Vdc=(K1−K5)Vg−Vbg expression 7

Incidentally, the value of the background contrast potential Vbg, the graphs and the table illustrated in FIG. 13 to FIG. 17, and the calculation expressions of the charge grid bias Vg and the development bias Vdc can be stored in, for example, the storage unit 72. The values when the graphs and the table are prepared can be suitably set by those skilled in the art based on, for example, a relation between a required image density value and a value of each bias when the image density value is obtained, each potential, laser power and the like.

In this embodiment, the toner image condition information is not updated at a time other than the time of the test pattern formation of the toner supply amount correction control. Thus, the updated toner image condition information is applied as the normal image forming condition until the next toner supply amount correction control is performed. That is, until the toner supply amount correction control is newly performed, the toner image formation in the image forming apparatus is performed by using the obtained toner image condition information.

Paper Passing Test

A paper passing test is performed using a monochrome laser printer to which this embodiment is applied. In this laser printer, a process speed (peripheral speed of a photoconductive drum) is 150 mm/sec, and a print speed is 45 sheets/minute. An environment is changed in the order of NN (23° C., 50% RH), HH (30° C., 85% RH), LL (10 C.°, 20% RH) and NN (23° C., 50% RH), the number of sheets is 20K in each of the environments and is 80K in total, and intermittent paper passing of five sheets of 6% print ratio chart (repetition of continuous printing of five sheets) is performed. As a developer, a new developer (start developer) having a toner density of 8.5 wt % is used.

The start-up timing of the toner supply amount correction control is set to the time of power ON. With respect to the start-up at the time of sleep return (fixing device power source is turned ON from OFF), the toner supply amount correction control is performed when the fixing device temperature is 50° C. or lower, when the integrated number of printed sheets becomes 100 sheets or more in terms of A4, or when the number of continuously printed sheets become 120 sheets or more in terms of A4. With respect to the humidity change, the toner supply amount correction control is performed when a variation of 15% RH (with respect to the humidity at the time of the last toner supply amount correction control) or more occurs.

Incidentally, when the toner supply amount control is performed based on the integrated number of printed sheets, the toner supply amount correction control is performed at the time of printing end. When the toner supply amount correction control is performed based on the number of continuously printed sheets, after printing of 120 sheets is performed, the printing is interrupted and the toner supply amount correction control is performed. The counter for the integrated number of printed sheets and the number of continuously printed sheets is cleared to zero by execution of the toner supply amount correction control at one of the start-ups.

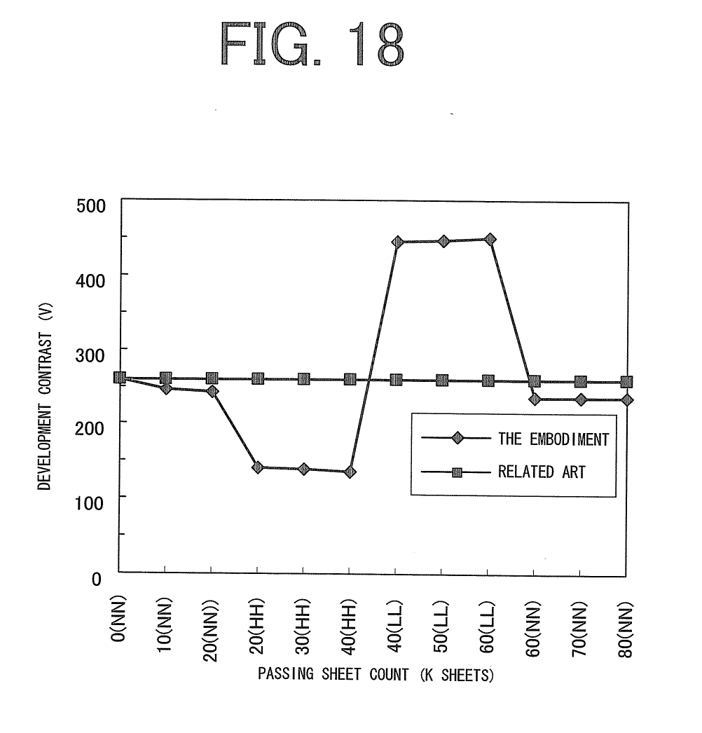

FIG. 18 is a graph showing the transition of the development contrast potential Vc with respect to the passing sheet count, and shows data set by the open-loop control in comparison with the related art (development contrast potential is constant).

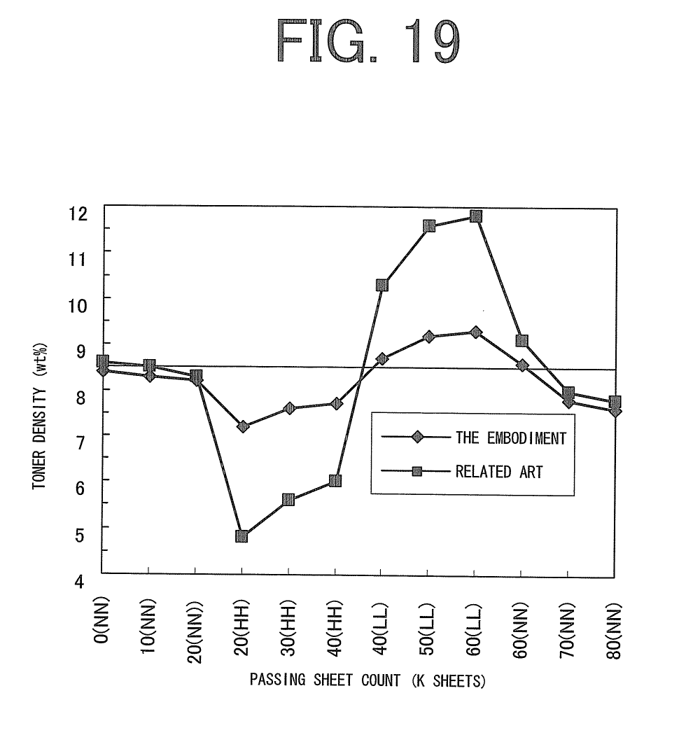

FIG. 19 is a graph showing the transition of the toner density with respect to the passing sheet count in comparison with the related art (development contrast potential is constant). In FIG. 19, when the change (open-loop control) of the development contrast potential is performed using the information relating to the temperature and humidity in the image forming apparatus and the developer life based on the embodiment, the variation width of the toner density of the developer is about ±1.5 wt %.

On the other hand, when the development contrast potential is constant as in the related art, the variation width of the toner density of the developer is ±4 wt %. Especially in the HH environment, the toner density is remarkably lowered (under toner), and a large amount of carrier is adhered to both an image portion and a non-image portion. On the other hand, in the LL environment, the toner density is remarkably increased (over toner), and a large amount of fogging occurs in a non-image portion.

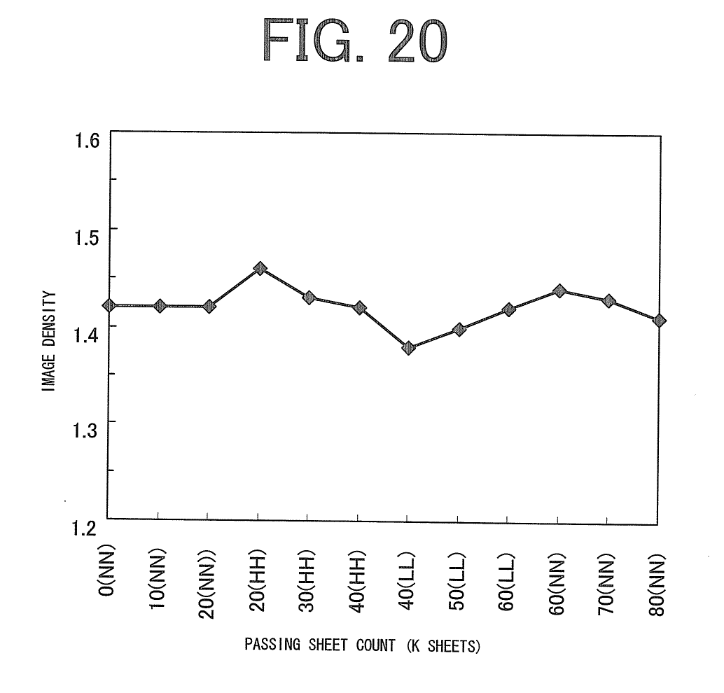

FIG. 20 is a graph showing the transition of the image density with respect to the passing sheet count. Incidentally, the related art (development contrast potential is constant) is not shown because image defects often occur. From FIG. 20, it is confirmed that when the change (open-loop control) of the development contrast potential is performed based on the temperature and humidity and the developer life based on the embodiment, influence due to the environment change or the developer use time is suppressed, and the stable image density is obtained.

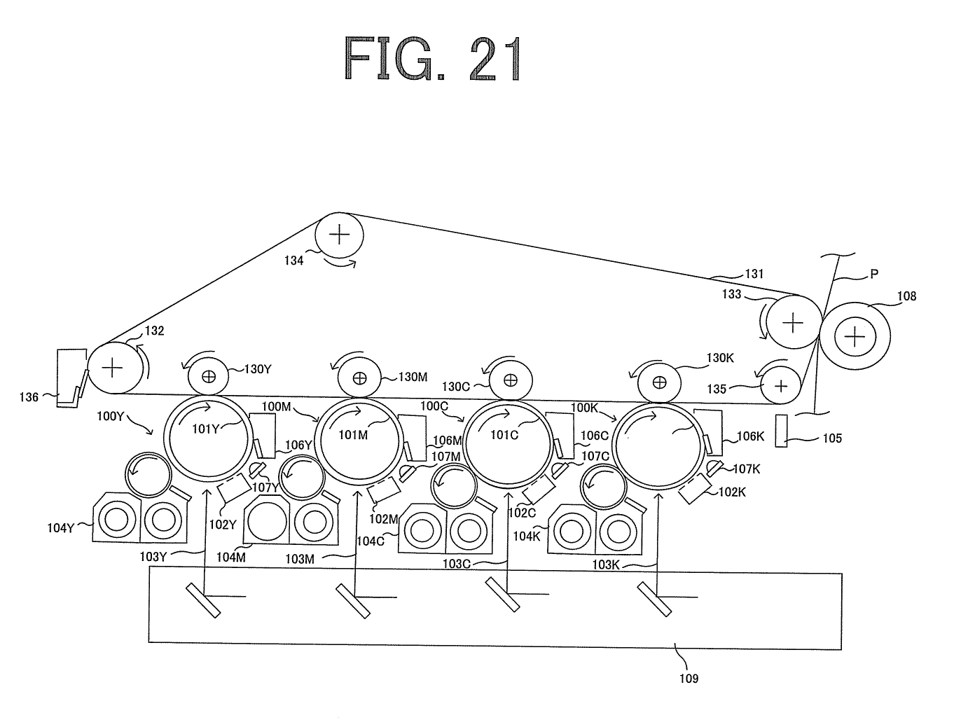

Schematic Structure of Another Embodiment FIG. 21 is a schematic sectional view of an image forming apparatus of another embodiment, and shows a tandem color image forming apparatus which uses toners of four colors of yellow, magenta, cyan and black, and includes image forming units including photoreceptors for the respective colors. In the drawing, first, in a yellow image forming unit 100Y, a corona charger 102Y, a laser beam 103Y irradiated from a laser exposure unit 109, a developing device 104Y, a cleaner 106Y and a charge removal lamp 107Y are arranged around a photoconductive drum 101Y having an organic photoconductor (OPC) on a surface and rotating in an arrow direction. Similarly, in a magenta image forming unit 100M, a cyan image forming unit 100C and a black image forming unit 100K, image forming members are arranged around respective photoconductive drums 101M, 101C and 101K. Primary transfer rollers 130Y, 130M, 130C and 130K to which primary transfer biases are applied for the respective colors are provided inside an intermediate transfer belt, which contacts the four-color photoconductive drums 101M, 101C, 101K at transfer positions (primary transfer), so as to contact therewith at appropriate pressure. The primary transfer rollers 130Y, 130M, 130C and 130K are driven and rotated by the rotation of the intermediate transfer belt 131, and toner images formed on the respective photoconductive drums 101M, 101C, 101K are transferred to the intermediate transfer belt. The intermediate transfer belt 131 is stretched between a drive roller 132 connected to a not-shown drive source and driven rollers 133, 134 and 135, and rotates in an arrow direction. The driven roller 134 is a tension roller. A cleaner 136 for the intermediate transfer belt is provided at the position of the drive roller 132. At the position of the driven roller 133, a secondary transfer roller 108 to which a secondary transfer bias is applied is provided so as to contact at appropriate pressure. The secondary transfer roller 108 is driven and rotated by the rotation of the intermediate transfer belt 131, and a toner image on the intermediate transfer belt 131 is transferred to a sheet P fed between the intermediate transfer belt 131 and the secondary transfer roller by a not-shown paper feed device. Besides, a toner adhesion amount sensor 105 is provided to face the intermediate transfer belt 131 at the position of the driven roller 135 at the downstream side of the black image forming unit 100K, and measures the toner adhesion amounts of test patterns of yellow, magenta, cyan and black sequentially formed on the intermediate transfer belt 131.

That is, in the another embodiment, the image forming apparatus includes the second image carrier (the intermediate transfer belt 131) to which the toner image formed on the first image carrier is transferred in addition to the first image carrier (the photoconductive drum). The toner adhesion amount information acquisition unit 77 acquires information relating to the toner adhesion amount of the toner image formed on the intermediate transfer belt 131.

When the toner adhesion amount sensor 105 is provided above the intermediate transfer belt 131 as in this embodiment, there is a merit that the one toner adhesion amount sensor 105 can measure the four color toner adhesion amounts.

Also in the color image forming apparatus of FIG. 21, for example, the toner supply amount correction control including the calculation of the image forming condition by the open-loop control described in FIG. 6 and the toner supply control are performed in parallel for the four colors, so that the same effect as that of the monochrome image formation can be obtained.

As described above, according to the image forming apparatus of the embodiment, even if the characteristics of the developer are changed by the variation of the temperature and humidity environment and the time elapsed from the start of use, the over toner (toner density is excessive) or the under toner (toner density is too low) of the developer is prevented, and the image forming apparatus can be provided in which fogging (scumming), toner scattering and carrier adhesion (carrier development) do not occur, and the image density is stable. Besides, since the toner density sensor is not required to be provided for the developing device, the inexpensive image forming apparatus, especially the inexpensive color image forming apparatus can be provided.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and method described herein may be made without departing from the spirit of the inventions. The accompanying claims and their equivalents are intended to cover such forms or modifications as would fall within the scope and spirit of the inventions.

As described above in detail, according to the technique disclosed in this specification, for example, even if a toner density sensor is not provided, a variation range of toner density of a developer is reduced, and the image forming apparatus can be provided in which an image having stable image density can be formed.

What is claimed is:

1. An image forming apparatus comprising:
an electrostatic latent image forming unit to form an electrostatic latent image corresponding to an image signal on an image carrier;
a developing unit that is applied with a voltage and develops the electrostatic latent image with a two-component developer including a toner and a carrier to form a toner image;
an apparatus information acquisition unit to acquire apparatus information as information relating to the image forming apparatus;
a toner image condition information acquisition unit that uses the apparatus information acquired by the apparatus information acquisition unit and acquires toner image condition information as information relating to a condition at a time of toner image formation by the electrostatic latent image forming unit and the developing unit;
a reference toner image forming unit that controls the electrostatic latent image forming unit and the developing unit based on the toner image condition information acquired by the toner image condition information acquisition unit and forms a reference toner image on the image carrier;
a toner adhesion amount information acquisition unit to acquire information relating to a toner adhesion amount in the reference toner image formed by the reference toner image forming unit; and
a supply amount correction unit that uses the information relating to the toner adhesion amount acquired by the toner adhesion amount information acquisition unit and corrects a toner supply amount to the developing unit.

2. The apparatus of claim 1, wherein
the electrostatic latent image forming unit includes a charging unit that is applied with a voltage and charges a surface of the image carrier, and an exposure unit to perform image exposure corresponding to the image signal onto the surface of the image carrier charged by the charging unit, and
the toner image condition information acquisition unit acquires the toner image condition information including information relating to the voltage applied to the charging unit, information relating to an exposure amount from the exposure unit, and information relating to the voltage applied to the developing unit.

3. The apparatus of claim 2, wherein
the apparatus information acquisition unit acquires the apparatus information including information relating to a temperature of the image carrier and information relating to a driving time from start of use of the image carrier, and
the toner image condition information acquisition unit uses the information relating to the temperature of the image carrier and the information relating to the driving time from the start of use of the image carrier and acquires the information relating to the exposure amount.

4. The apparatus of claim 3, wherein
the apparatus information acquisition unit acquires the apparatus information including information relating to a temperature in the image forming apparatus, information relating to a humidity in the image forming apparatus, and information relating to the number of times of development from start of use of the developer,
the toner image condition information acquisition unit uses the information relating to the temperature in the image forming apparatus, the information relating to the humidity in the image forming apparatus and the information relating to the number of times of development from the start of use of the developer, and acquires information relating to a development contrast potential as a potential difference between the voltage applied to the developing unit and a post-exposure potential of the image carrier, and
the toner image condition information acquisition unit uses the information relating to the development contrast potential, the information relating to the temperature of the image carrier, the information relating to the driving time of the image carrier and the information relating to the exposure amount, and acquires information relating to the voltage applied to the charging unit and information relating to the voltage applied to developing unit.

5. An image forming method comprising:
acquiring apparatus information as information relating to an image forming apparatus including an electrostatic latent image forming unit to form an electrostatic latent image corresponding to an image signal on an image carrier, and a developing unit that is applied with a voltage and develops the electrostatic latent image with a two-component developer including a toner and a carrier to form a toner image;
acquiring toner image condition information as information relating to a condition at a time of toner image formation by the electrostatic latent image forming unit and the developing unit by using the acquired apparatus information;
forming a reference toner image on the image carrier by controlling the electrostatic latent image forming unit and the developing unit based on the acquired toner image condition information;
acquiring information relating to a toner adhesion amount in the formed reference toner image; and
correcting a toner supply amount to the developing unit by using the acquired information relating to the toner adhesion amount.

6. The method of claim 5, wherein
the electrostatic latent image forming unit includes a charging unit that is applied with a voltage and charges a surface of the image carrier, and an exposure unit to perform image exposure corresponding to the image signal onto the surface of the image carrier charged by the charging unit, and
the toner image condition information including information relating to the voltage applied to the charging unit, information relating to an exposure amount from the exposure unit, and information relating to the voltage applied to the developing unit is acquired.

7. The method of claim 6, wherein
the apparatus information including information relating to a temperature of the image carrier and information relating to a driving time from start of use of the image carrier is acquired, and
the information relating to the exposure amount is acquired by using the information relating to the temperature of the image carrier and the information relating to the driving time from the start of use of the image carrier.

8. The method of claim 7, wherein
the apparatus information including information relating to a temperature in the image forming apparatus, information relating to a humidity in the image forming apparatus and information relating to the number of times of development from start of use of the developer is acquired,
information relating to a development contrast potential as a potential difference between the voltage applied to the developing unit and a post-exposure potential of the image carrier is acquired by using the information relating to the temperature in the image forming apparatus, the information relating to the humidity in the image forming apparatus and the information relating to the number of times of development from the start of use of the developer, and
information relating to the voltage applied to the charging unit and information relating to the voltage applied to the developing unit are acquired by using the information relating to the development contrast potential, the information relating to the temperature of the image carrier, the information relating to the driving time of the image carrier and the information relating to the exposure amount.
